(19) United States
(12) Patent Application Publication
(10) Pub. No.: US 2005/0015468 A1
(43) Pub. Date: Jan. 20, 2005

(54) Method and system for propogating points of presence over a computer network

(76) Inventors: Boey-Kin Lim, Singapore (SG); Choong-Hung Cheng, Singapore (SG); Mun-Kew Leong, Singapore (SG)

Correspondence Address: CONLEY ROSE, P.C., P. O. BOX 3267, HOUSTON, TX, 77253-3267, US

(21) Appl. No.: 10/488,120

(22) PCT Filed: Aug. 28, 2001
(86) PCT No.: PCT/SG01/00173

(51) Int. Cl. G06F 15/177

(52) U.S. Cl. 709/220

(57) ABSTRACT

This invention proposes a system which supports controlled recursive propagation of points of presence on connected networks, where the network is the internet, and the points of presence are functional or informational banners hosted by websites and displayable on HTML, javascript and/or java enabled browsers. In addition the points of presence support informational of functional communication between a plurality of designated origin servers and the points of presence. This allows data on the use, location, and other characteristics of the interaction between the user and the points of presence to be captured, transmitted, aggregated, stored, and/or manipulated as necessary. The said communication also allows the implementation of access permissions, registrations, or other forms of control. Similar data and communication is supported for the websites hosting the points of presence. This allows the data and the communication to be leveraged for any required purpose including not limited to incentive schemes and rewards.

### FIELD OF INVENTION

The invention relates generally to a method for propagating points of presence over a computer network. The invention relates particularly but not exclusively to a method of controlling the propagation of points of presence over a computer network such as the Internet.

### BACKGROUND TO THE INVENTION

A point of presence is a set of programming codes that provide a display of specific information at a particular point. Common examples of points of presence are banner advertisements, search buttons and banner games.

The function of these points of presence is to implicitly or explicitly raise awareness of the information presented or the function served by the point of presence. Points of presence are formed in an attempt to induce the user to make use of the information presented or to use the functionality that is made available by the point. For example, where the point of presence is a banner advertisement the ultimate aim is to entice users to click on the banner and follow it through to the site being advertised. Where the point of presence is a search engine the ultimate aim is to ensure that users use the engine as their preferred searching tool.

One measure of the worth of a point of presence is the number of users who are exposed to the point through reading, viewing or usage. The higher the exposure the more valuable the point becomes. Downloading the point of presence onto various sites helps in exposing the point of presence to additional traffic and consequently boosting exposure with the prospect of attracting further users who may read, view or use it.

A webmaster who has a large site may wish to make a search engine available to users of the site. As an alternative to programming his/her own search engine into the site the webmaster may choose the option of installing a functional point of presence in the form of a search engine. This type of point of presence will typically be branded with the point of presence logo to advertise the origin of the point of presence in addition to providing functionality as a search tool. This provides the webmaster with functionality on his/her site while providing the point of presence with further exposure through propagation.

Current systems of propagation rely on direct propagation, that is propagation directly from the original point of presence. Where a Webmaster wishes to propagate the point of presence he/she must follow links back to the original host site to download the point of presence. Accordingly, only users who visit the original host site can propagate the point of presence. This method of propagation provides a limited one-level recursion dependant on the flow traffic to the original point of presence. A problem arises where the original point of presence and other points hosting the point have low traffic levels. In this situation there is no real ability to leverage traffic from related or affiliated sites to increase propagation of the point of presence.

Control is also an important aspect in the propagation of points of presence. There is typically no control over the propagation and accordingly the original site has little knowledge of where the point has propagated and little or no control over when it propagates. An example of this is a non-web based environment, such as electronic mail, where a chain electronic mail is propagated. These can be propagated with little control and continue to propagate for years after they are first distributed. In these situations the original point has effectively lost control of who sends and receives the electronic mail. There is also no method of determining where the mail has been propagated.

The object of the present invention is to address some or all of the disadvantages present in the prior art.

### SUMMARY OF INVENTION

In a first aspect of the present invention there is provided a method of propagating points of presence over a computer network, including the steps of:
(a) locating an origin point on the computer network, the origin point providing an initial location of the point of presence;
(b) transferring between the origin point and one or more host points installation information which allows for installation of the point of presence at the host point;
(c) installing the point of presence at one or more host points;
(d) designating one or more of the host points as node host points, being host points which can receive a request to propagate the point of presence;
(e) one of the node host points receiving a request to propagate the point of presence from a prospective host point;
(f) upon receipt of the request to propagate the node host point informing the origin point of the request to propagate;
(g) the installation information being transferred to the prospective host point allowing for the installation of the point of presence at the prospective host point to create a further host point.

The installation information can be transferred from the node host point to the prospective host point. The installation information may also be transferred from the origin point to the prospective host point.

Preferably, an authorisation is required from the origin point before the installation information is transferred to the prospective host point.

In a further preferred form, information including any one or more of the following is transferred to the origin point by the node host point:
(a) information pertaining to the prospective host point;
(b) circumstances existing at the time transfer, and
(c) information regarding the point of presence.

The origin point may also contact the prospective host point to request further information. Payment may be received for propagation of the point of origin; in this case the origin point may contact the prospective host point to request payment for propagation of the point of presence. Specific information may also be transferred from one or more of the host points to the origin point upon fulfillment of one or more predetermined conditions.

In a second aspect, the invention provides a propagated system of points of presence located on a computer network, including the following components:
(a) an origin point, being an initial location of the point of presence;
(b) one or more host points, being locations other than the origin point, which host the point of presence;
(c) one or more node host points, being host points which can receive a request to propagate the point of presence;
(d) a relaying means for relaying information from the node host point to the origin point when a request to propagate is received at the node host point, the request being made by a prospective point of presence; and
(e) a transferring means for transferring installation information to a prospective point of presence which allows for the prospective point of presence to receive information with which to create a further host point of presence.

The transferring means may transfer the installation information from the node host point to the prospective host point. Alternatively, the transfer means may transfer the installation information from the origin point to the prospective host point.

Preferably, the system requires that an authorisation be obtained from the origin point before the transfer means operates to transfer the installation information.

In a further preferred form, the transfer means provides for transfer of any one or more of the following types of information between the origin point and the host point:
(a) information pertaining to the prospective host point;
(b) circumstances existing at the time of transfer; and
(c) information regarding the point of presence.

In a still further preferred form, the transfer means provides for the transferring of information from one or more host points to the origin point upon fulfillment of one or more predetermined conditions.

### BRIEF DESCRIPTION OF DRAWING

The invention will hereinafter be described in greater detail by reference to the attached drawing, which illustrates an example form of the invention. It is to be understood that the particularity of the drawing does not supersede the generality of the preceding description of the invention. In the drawing:

FIG. 1 is a schematic diagram showing propagation of a point of presence.

### DETAILED DESCRIPTION

Where the computer network is the Internet a point of presence (POP) can be functional or informational banners hosted by websites and displayable to user accessing the websites where the POP is installed. The POP can then be displayable in a variety of formats including on HTML, JavaScript and/or java enabled browsers.

A suitable method of propagation of a POP consists of downloading the code comprising the POP. That code can then be installed in another website forming a host POP. This system becomes recursive; that is, it allows further propagation, when a further POP is downloaded from a host POP. There is no need for the user who wishes to propagate to go back to the origin point where the POP was initially provided for downloading. The user can interact with the host POP to effect the propagation. When a request for propagation is made the origin point is informed. This allows for the origin to maintain a record of where each POP is located. The propagation can further be controlled by requiring authorisation from the origin point before the host can allow propagation of the POP.

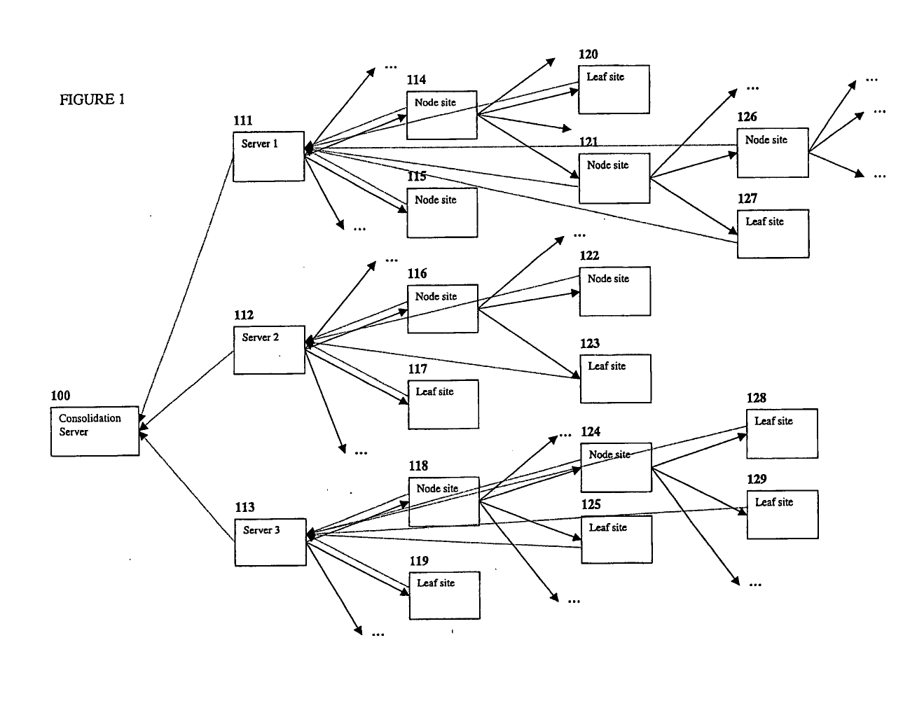

The propagation of POP according to an embodiment of the invention is illustrated in FIG. 1. The origin point (100) is initially located on the computer network. Installation information for the POP is transferred between the origin and the host points (111,112,113) allowing installation of the point of presence at these locations (111,112,113).

Host points can be provided which are classified according to whether there is further propagation allowed from that particular point. Where a host point allows propagation, it is defined as a node host point. Where the host point does not allow further propagation then it is a host leaf site (117, 119, 120, 123, 125, 127, 128, 129). Both types of host points otherwise contain the full functionality of the point of presence.

A request to download a point of presence can be made and received at a node host point, whether from the initial node host point servers (111, 112, 113) or from a node host point which has propagated from another node host point (114, 115,116, 118, 121, 122, 124, 126). Where a request is made to a node host point, by a prospective point, for propagation to that point a bi-directional connection, as shown by dotted lines, is established back to the origin point of presence (100). This communication between the node host point receiving the request and the origin point may influence, amend, or otherwise control the download request.

Where the POP is transferred to another point then that point becomes a host point. This results in a tree-like network of POPs with each starting with the origin point (100) and one or more initial node host points (111, 112, 113).

The origin point (100) can be used to co-ordinate the spread of node host points by authorising the propagation of a POP and retrieving information from the POPs regarding their activity.

An advantage of the invention is that it promotes propagation of desired POPs by leveraging traffic from other websites. In particular, it allows propagation of the POP through implicit or explicit relationships with other websites or hosts. There is no need to return to the origin to download the POP.

A further advantage of the invention is that, in one form, the origin website can be used to track the characteristics and usage of the points of presence as they are propagated. This is in addition to the usual tracking of the characteristics and usage of the information or functions in the POP. The tracked information in both cases can include but is not limited to data on the use, location, and other characteristics of the interaction between the user and the points of presence. After capture, the tracked information may be transmitted, aggregated, stored, and/or manipulated as necessary.

Another advantage of the invention is that it allows a system running on an origin point (which may be a website) to track and control the propagation of the said points of presence from other website hosts. The points of presence may support informational or functional communication with the origin website. Before the transfer of a point of presence from a given host, relevant information as to the circumstances of the download can be communicated from the host website to the origin website. The origin website may in turn communicate with the host website or prospective host website. The communication may include and is not limited to permission to propagate, requests for payment, requests for further information, denial of download and revocation of the host status of a host website. In at least one form, the origin website and the host website are the same.

The components according to an embodiment of the invention include a set of computer codes forming the point of presence. This set of code can be part of a host website when executed by an HTML, JavaScript, and/or Java capable browser. This can be displayed as a logical unit on that host website as a banner.

The code can be programmed to allow the POP code to be transported. This enables propagation to form a further host website. When a request to initiate propagation is received at a node host site the information on propagation is transferred to the origin point providing a record of where the POP has propagated. The code may include functionality that requires an authorisation from the origin point before allowing transport of the codes to a prospective host point.

### EXAMPLE

The following example illustrates the present invention in further detail. It is to be understood that the particularity of this example should not be construed as limiting the scope of the invention.

Consider a website such as SurfIP.com hosting a search banner on their home page. This search banner is a point of presence that can be transferred to other host points. A Webmaster for a site such as IPMenu.com who wishes to adopt the functionality of the search banner may decide to adopt the POP for their site. The Webmaster will then click on the search banner which will lead him to the SurfIP site and accordingly lead him to a dialogue which allows him to download the SurfIP search banner, being a POP, onto his internet page. When the webmaster of IPMenu asks to download the search banner, a dialogue is initiated with the SurfIP server where he has to register with SurfIP as an affiliate and to virtually sign a legal agreement with SurfIP.

If the search banner downloaded onto IPMenu is designated as a node host site then it can be further downloaded by another user. If a Webmaster from another site, such as Patent Cafe, desires to download the search banner from IPMenu then a dialogue will be initiated through the IPMenu site to the SurfIP site allowing the Webmaster to receive code to install the point of presence to forming another host site.

The search banner may be downloaded from the initial server (SurfIP) or from a node host point (IPMenu). While it is not necessary to go back to the origin POP, a dialogue is established with the initial origin server (SurfIP) to control propagation of the banner.

While the present invention has been described by reference to a drawing and an example to illustrate preferred embodiments, it should be readily apparent to those of ordinary skill in the art that changes and modifications in form and details may be made without departing from the spirit and scope of the invention.

1. A method of propagating points of presence over a computer network, including the steps of:
(a) locating an origin point on the computer network, the origin point providing an initial location of the point of presence;
(b) transferring between the origin point and one or more host points installation information which allows for installation of the point of presence at the host point;
(c) installing the point of presence at one or more host points;
(d) designating one or more of the host points as node host points, being host points which can receive a request to propagate the point of presence;
(e) one of the node host points receiving a request to propagate the point of presence from a prospective host point;
(f) upon receipt of the request to propagate the node host point informing the origin point of the request to propagate;
(g) the installation information being transferred to the prospective host point allowing for the installation of the point of presence at the prospective host point to create a further host point.

2. A method according to claim 1 wherein the installation information is transferred from the node host point to the prospective host point.

3. A method according to claim 1 wherein the installation information is transferred from the origin point to the prospective host point.

4. A method according to any one of the preceding claims wherein an authorisation is required from the origin point before the installation information is transferred to the prospective host point.

5. A method according to any one of the preceding claims wherein information including any one or more of the following is transferred to the origin point by the node host point:
(a) information pertaining to the prospective host point;
(b) circumstances existing at the time transfer; and
(c) information regarding the point of presence.

6. A method according to any one of the preceding claims wherein the origin point contacts the prospective host point to request further information.

7. A method according to any one of the preceding claims wherein the origin contacts the prospective host point to request payment for propagation of the point of presence.

8. A method according to any one of the preceding claims wherein one or more host points transfer predetermined information to the origin upon fulfillment of one or more predetermined conditions.

9. A propagated system of points of presence located on a computer network, including the following components:
(a) an origin point, being an initial location of the point of presence;
(b) one or more host points, being locations other than the origin point which host the point of presence;
(c) one or more node host points, being host points which can receive a request to propagate the point of presence;
(d) a relaying means for relaying information from the node host point to the origin point when a request to propagate is received at the node host point, the request being made by a prospective point of presence; and
(e) a transferring means for transferring installation information to a prospective point of presence which allows for the prospective point of presence to receive information with which to create a further host point of presence.

10. A system according to claim 9 wherein the transferring means transfers the installation information from the node host point to the prospective host point.

11. A system according to claim 9 wherein the transferring means transfers the installation information from the origin point to the prospective host point.

12. A system according to any one of claims 9, 10 or 11 wherein the system requires that an authorisation be obtained from the origin point before the transfer means operates to transfer the installation information.

13. A system according to any one of claims 9 to 12 wherein transfer means can additionally transfer any one or more of the following types of information between the origin point and the host point:
(a) information pertaining to the prospective host point;
(b) circumstances existing at the time of transfer; and
(c) information regarding the point of presence.

15. A system according to any one of claims 9 to 14 wherein the transfer means can additionally transfer information from one or more host points to the origin point upon fulfillment of one or more predetermined conditions.
